(19) United States
(12) Patent Application Publication
(10) Pub. No.: US 2014/0055335 A1
(43) Pub. Date: Feb. 27, 2014

(54) CONTROL CIRCUIT FOR BACKLIGHT MODULE OF ELECTRONIC DEVICE

(71) Applicant: Chi Mei Communication Systems, Inc., New Taipei (TW)

(72) Inventor: PO-YEN LIU, New Taipei (TW)

(21) Appl. No.: 13/920,054

(22) Filed: Jun. 17, 2013

(30) Foreign Application Priority Data
Aug. 27, 2012 (TW) 101130934

(51) Int. Cl. G09G 5/10

(52) U.S. Cl. CPC G09G 5/10
USPC 345/102

(57) ABSTRACT

A control circuit for a backlight module of an electronic device includes a power supply unit, a sensor, an analog-digital converter (ADC), and a processor. The power supply unit provides power to the backlight module. The sensor senses a temperature of a display panel, and transmits a temperature value to the ADC. The processor compares the temperature value with a pre-stored temperature threshold. If the temperature value is greater than the temperature threshold, the processor controls the power supply unit to reduce an illumination cycle time and brightness of the backlight module.

### BACKGROUND

1. Technical field

The disclosure generally relates to control circuits, and particularly to a control circuit for a backlight module of an electronic device.

2. Description of the Related Art

Light emitting diodes (LEDs) are widely used in electronic devices, such as mobile phones, to serve as a backlight module of the electronic device. However, heat generated by the LEDs may cause them to overheat, reducing their life and possibly causing damage to nearby components.

Therefore, there is room for improvement within the art.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment.

FIG. 1 is a circuit view of a control circuit for an electronic device, according to a first exemplary embodiment.

FIG. 2 is a circuit view of a control circuit for an electronic device, according to a second exemplary embodiment.

### DETAILED DESCRIPTION

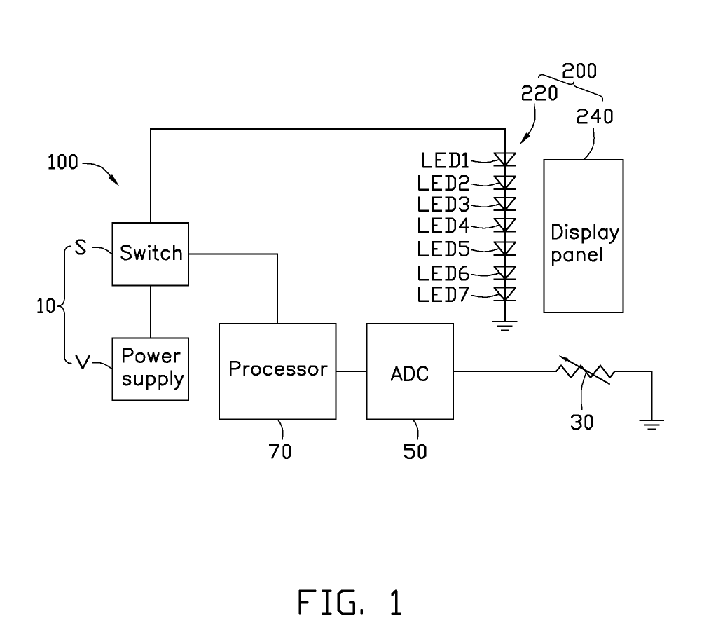

FIG. 1 is a circuit view of a control circuit 100 for an electronic device, according to a first exemplary embodiment. The control circuit 100 can be used in an electronic device 200, such as a mobile phone, for example. The electronic device 200 further includes a backlight module 220 and a display panel 240. The backlight module 220 is directed by the control circuit 100 to provide light for the display panel 240.

The backlight module 220 includes a plurality of light emitting diodes (LEDs). In one exemplary embodiment, number of the LEDs is seven. The seven LEDs are electronically connected in series, and are labeled as LED1, LED2, LED3, LED4, LED5, LED6, and LED7, respectively.

The control circuit 100 includes a power supply unit 10, a sensor 30, an analog-digital converter (ADC) 50, and a processor 70.

The power supply unit 10 provides power to the backlight module 200 to activate the LEDs. In one exemplary embodiment, the power supply unit 10 includes a power supply V and a switch S. The power supply V is connected to an anode of the LED1 via the switch S, and a cathode of the LED7 is grounded.

In one exemplary embodiment, the sensor 30 is a thermistor, and is positioned adjacent to the display panel 240 or at other suitable locations to sense a temperature of the display panel 240. A first end of the sensor 30 is electronically connected to the ADC 50, and a second end of the sensor 30 is grounded. A resistance value of the sensor 30 changes along with the temperature of the display panel 240, which generates an analog signal indicating a relationship between the resistance value of the sensor 30 and the temperature of the display panel 240.

The ADC 50 converts the analog signal provided by the sensor 30 into a digital signal, and obtains a temperature value of the display panel 240 accordingly. The ADC 50 is electronically connected to the processor 70 to output the temperature value to the processor 70.

The processor 70 is electronically connected to the switch S to output a pulse width modulation (PWM) signal to the switch S, to turn on/off the switch S with a certain frequency. In addition, the processor 70 pre-stores a temperature threshold. The processor 70 compares the temperature value output from the ADC 50 with the temperature threshold, and adjusts a duty ratio of the PWM signal according to the result of comparison. If the temperature value is less than or equal to the temperature threshold, the duty ratio of the PWM signal will not be changed by the processor 70. If the temperature value is greater than the temperature threshold, the processor 70 reduces the duty ratio of the PWM signal.

In use, the backlight module 220 twinkles or flashes to light the display panel 240. The sensor 30 senses the temperature of the display panel 240, and outputs the analog signal to the ADC 50. The ADC 50 converts the analog signal into the digital signal, and obtains the temperature value of the display panel 240. The processor 70 compares the temperature value with the temperature threshold. If the temperature value is greater than the temperature threshold, the processor 70 reduces the duty ratio of the PWM signal. Thus, an illumination cycle time of the backlight module 220 is reduced, thus brightness of the backlight module 220 is also reduced. Then, the temperature of the display panel 240 steadily decreases.

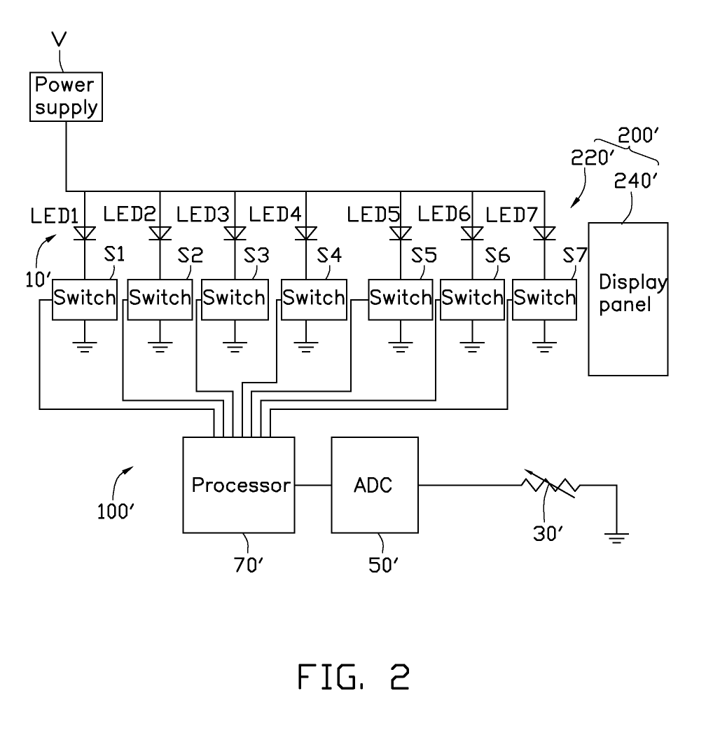

Referring to FIG. 2, in a second exemplary embodiment, the LED1-LED7 are electronically connected in parallel. The power supply unit 10′ includes a power supply V and switches S1, S2, S3, S4, S5, S6 and S7. Anodes of the LED1-LED7 are electronically connected to the power supply V, and cathodes of the LED1-LED7 are grounded via the switches S1-S7 respectively. The processor 70′ outputs a PWM signal to each of the switches S1-S7. When the temperature value is greater than the temperature threshold, the processor 70′ reduces brightness of at least one of the LED1-LED7 by reducing the duty ratio of a corresponding PWM signal. For example, the processor 70′ reduces the duty ratio of the PWM signal outputting to the LED2, LED4, and LED6 to reduce their brightness.

In summary, the sensor 30 obtains the temperature of the display panel 240, and the processor 70 compares the temperature value with the temperature threshold and adjusts the backlight module 220 accordingly. Thus, the brightness of the backlight module 220 can be adjusted to balance the temperature of the display panel 240. The control circuit 100 is efficient.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A control circuit for an electronic device comprising a display panel and a backlight module lighting the display panel, the control circuit comprising:
a power supply unit providing power to the backlight module;
a sensor sensing a temperature of the display panel;
an analog-digital converter (ADC) obtaining a temperature value according to the temperature sensed by the sensor; and
a processor comparing the temperature value with a temperature threshold;
wherein if the temperature value is greater than the temperature threshold, the processor controls the power supply unit to reduce brightness of the backlight module.

2. The control circuit as claimed in claim 1, wherein the sensor generates an analog when the sensor senses the temperature of the display panel, and the ADC converts the analog signal into a digital signal to obtain the temperature value.

3. The control circuit as claimed in claim 1, wherein the backlight module includes a plurality of light emitting diodes (LEDs) electronically connected in series, the power supply unit includes a power supply and a switch, the power supply is connected to an anode of one of the plurality of LEDs via the switch.

4. The control circuit as claimed in claim 3, wherein the processor is electronically connected to the switch to output a pulse width modulation (PWM) signal to the switch, to turn on/off the switch.

5. The control circuit as claimed in claim 4, wherein if the temperature value is greater than the temperature threshold, the processor reduces a duty ratio of the PWM signal to reduce an illumination cycle time of the backlight module.

6. The control circuit as claimed in claim 1, wherein the backlight module includes a plurality of light emitting diodes (LEDs) electronically connected in parallel, the power supply unit includes a power supply and a plurality of switches, anodes of the plurality of LEDs are electronically connected to the power supply, and cathodes of the LEDs are grounded via the switches, respectively.

7. The control circuit as claimed in claim 6, wherein the processor outputs a PWM signal to each of the switches to turn on/off the switches.

8. The control circuit as claimed in claim 7, wherein if the temperature value is greater than the temperature threshold, the processor reduces a duty ratio of at least one of the PWM signals to reduce the illumination cycle time of at least one of the plurality of LEDs.

9. The control circuit as claimed in claim 1, wherein the sensor is a thermistor, and is positioned adjacent to the display panel.

10. A control circuit for an electronic device comprising a display panel and a plurality of light emitting diodes (LEDs) lighting for the display panel, the control circuit comprising:
a power supply unit providing power to the plurality of LEDs;
a sensor sensing a temperature of the display panel;
an analog-digital converter (ADC) obtaining a temperature value according to the temperature sensed by the sensor; and
a processor comparing the temperature value with a temperature threshold;
wherein if the temperature value is greater than the temperature threshold, the processor controls the power supply unit to reduce an illumination cycle time of at least one of the plurality of LEDs.

11. The control circuit as claimed in claim 10, wherein the plurality of LEDs are electronically connected in series, the power supply unit includes a power supply and a switch, the power supply is connected to an anode of one of the plurality of LEDs via the switch.

12. The control circuit as claimed in claim 11, wherein the processor is electronically connected to the switch to output a pulse width modulation (PWM) signal to the switch, to turn on/off the switch.

13. The control circuit as claimed in claim 12, wherein if the temperature value is greater than the temperature threshold, the processor reduces a duty ratio of the PWM signal to reduce the illumination cycle time of the plurality of LEDs.

14. The control circuit as claimed in claim 10, wherein the plurality of LEDs are electronically connected in parallel, the power supply unit includes a power supply and a plurality of switches, anodes of the plurality of LEDs are electronically connected to the power supply, and cathodes of the LEDs are grounded via the switches, respectively.

15. The control circuit as claimed in claim 14, wherein the processor outputs a PWM signal to each of the switches to turn on/off the switches.

16. The control circuit as claimed in claim 15, wherein if the temperature value is greater than the temperature threshold, the processor reduces a duty ratio of at least one of the PWM signals to reduce the illumination cycle time of at least one of the plurality of LEDs.
